(19) United States
(12) Patent Application Publication
(10) Pub. No.: US 2024/0418532 A1
(43) Pub. Date: Dec. 19, 2024

(54) CROWDSOURCED RADAR MAP GENERATION

(71) Applicant: QUALCOMM Incorporated, San Diego, CA (US)

(72) Inventors: Mehmet Can HUCUMENOGLU, La Jolla, CA (US); Mandar Narsinh KULKARNI, Bridgewater, NJ (US); Jubin JOSE, Basking Ridge, NJ (US)

(21) Appl. No.: 18/334,313

(22) Filed: Jun. 13, 2023

(51) Int. Cl. G01C 21/00

(52) U.S. Cl. CPC G01C 21/3841; G01C 21/3893

(57) ABSTRACT

Crowdsourced radar map generation techniques are disclosed. The techniques can include collecting a set of localized observation data for a map region of a radar reference map, the set of localized observation data including respective data received from each of a plurality of vehicles, dividing the set of localized observation data for the map region into a first observation data subset and a second observation data subset, determining occupancy probability parameters for the map region based on the first observation data subset, validating the occupancy probability parameters based on the second observation data subset, and updating the radar reference map according to the occupancy probability parameters.

### BACKGROUND

### 1. Field of Disclosure

Aspects of the present disclosure generally relate to radar map generation and, more specifically to generating a radar reference map for use in localization and pose determination of an autonomous vehicle.

### 2. Description of Related Art

Radar map generation involves creating a reference map to support high-accuracy (such as centimeter-level accuracy) localization and pose determination on the part of autonomous vehicles operating in a geographic domain of the reference map. Although it may often be possible for such autonomous vehicles to conduct highly-accurate localization and pose determination without reference to a radar reference map (such as by using global positioning devices, cameras, and light detection and ranging (lidar) sensors), these may not support highly accurate localization and pose determination under some conditions. For instance, cameras and lidar sensors may be unreliable at night or in the presence of fog, smoke, or precipitation, and global positioning devices may be unreliable in underground, tunnel, and “urban canyon” scenarios. Under such challenging conditions, which may generally not impair the accuracy of radar sensors, localization and pose determination based on radar sensor data using a radar reference map can yield greater levels of accuracy than may otherwise be achievable.

### BRIEF SUMMARY

An example radar map generation method, according to this disclosure, may include collecting a set of localized observation data for a map region of a radar reference map, the set of localized observation data including respective data received from each of a plurality of vehicles, dividing the set of localized observation data for the map region into a first observation data subset and a second observation data subset, determining occupancy probability parameters for the map region based on the first observation data subset, validating the occupancy probability parameters based on the second observation data subset, and updating the radar reference map according to the occupancy probability parameters.

An example apparatus for radar map generation, according to this disclosure, may include a communication interface, a memory, and one or more processors communicatively coupled with the communication interface and the memory, where the one or more processors are configured to collect, via the communication interface, a set of localized observation data for a map region of a radar reference map, the set of localized observation data including respective data received from each of a plurality of vehicles, divide the set of localized observation data for the map region into a first observation data subset and a second observation data subset, determine occupancy probability parameters for the map region based on the first observation data subset, validate the occupancy probability parameters based on the second observation data subset, and update the radar reference map according to the occupancy probability parameters.

An example apparatus for radar map generation, according to this disclosure, may include means for collecting a set of localized observation data for a map region of a radar reference map, the set of localized observation data including respective data received from each of a plurality of vehicles, means for dividing the set of localized observation data for the map region into a first observation data subset and a second observation data subset, means for determining occupancy probability parameters for the map region based on the first observation data subset, means for validating the occupancy probability parameters based on the second observation data subset, and means for updating the radar reference map according to the occupancy probability parameters.

An example non-transitory computer-readable medium, according to this disclosure, may store instructions for radar map generation, the instructions including code for collecting a set of localized observation data for a map region of a radar reference map, the set of localized observation data including respective data received from each of a plurality of vehicles, dividing the set of localized observation data for the map region into a first observation data subset and a second observation data subset, determining occupancy probability parameters for the map region based on the first observation data subset, validating the occupancy probability parameters based on the second observation data subset, and updating the radar reference map according to the occupancy probability parameters.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a block diagram illustrating a first example operating environment, according to aspects of the disclosure.

FIG. 3 illustrates an example of a mapping grid, according to aspects of the disclosure.

FIG. 4 is a block diagram illustrating a second example operating environment, according to aspects of the disclosure.

FIG. 5 is a block diagram illustrating a first example map generation method, according to aspects of the disclosure.

FIG. 6 is a block diagram of an embodiment of a computer system, which can be utilized in embodiments as described herein.

FIG. 7 is a block diagram illustrating a second example map generation method, according to aspects of the disclosure.

FIG. 8 is a diagram illustrating example components of a vehicle, according to aspects of the disclosure.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to radar map generation, and more particularly to generating a radar reference map for use in localization and pose determination of an autonomous vehicle. Some aspects more specifically relate to generating a crowdsourced radar reference map based on localized observation data provided by vehicles that operate in a geographic domain of the crowdsourced radar reference map. According to aspects of the disclosure, vehicles that travel within a given map region can use radar sensors to capture radar point clouds and can include localized observation data describing the radar point clouds in reports that they send to a map generation system. The localized observation data can also include vehicle pose data, which the map generation system can use to place the radar point clouds within a global reference frame. The map generation system can determine occupancy probability parameters for cells of the map region based on some of the received localized observation data, according to a static occupancy grid (SOG) mapping algorithm. The map generation system can validate the occupancy probability parameters using the remaining received localized observation data (or a portion thereof). According to aspects of the disclosure, the map generation system can determine the occupancy probability parameters using a recursive process, in conjunction with which occupancy probabilities can be recurringly updated via Bayesian update, according to an inverse sensor model (ISM). Using techniques disclosed herein, a crowdsourced radar reference map can be generated that is of sufficient detail and accuracy for use to support highly precise radar-based localization and pose determination on the part of autonomous vehicles under challenging conditions.

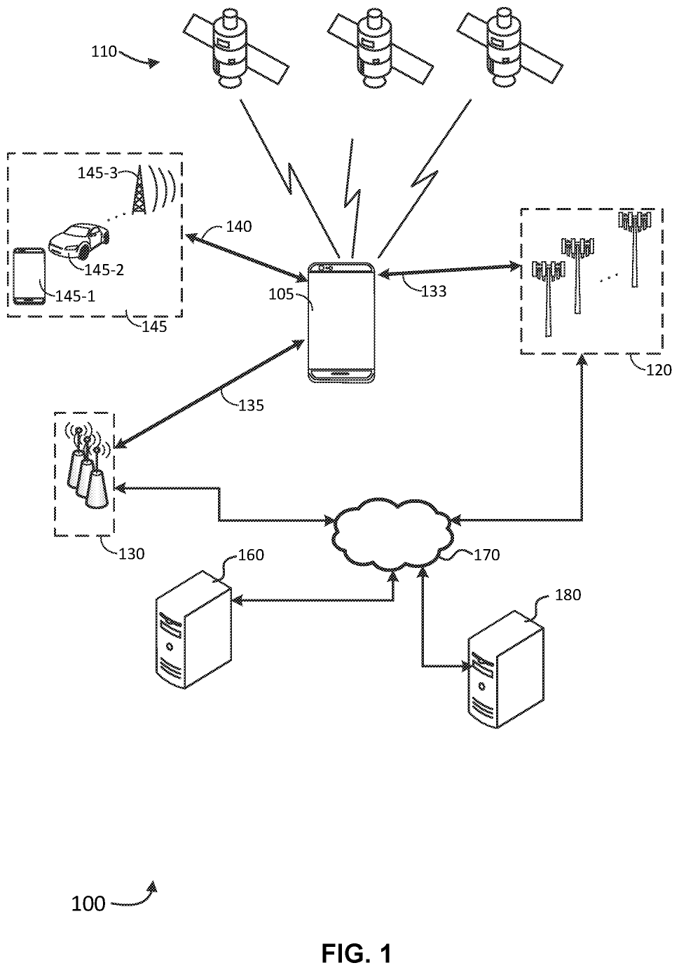

FIG. 1 is a simplified illustration of a positioning system 100 in which a UE 105, location server 160, and/or other components of the positioning system 100 can use the techniques provided herein for crowdsourced radar map generation, according to an embodiment. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Tvpe Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

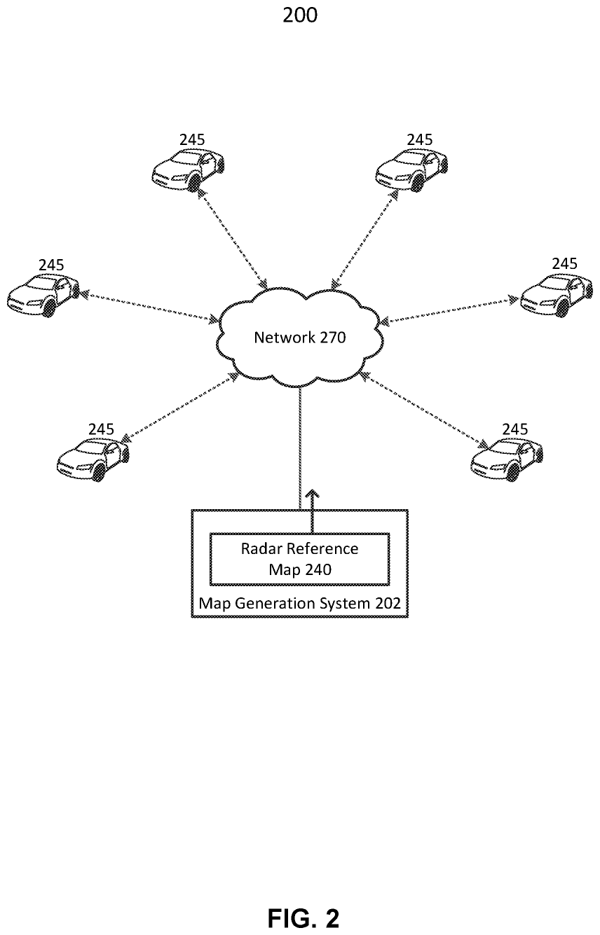

FIG. 2 is a block diagram illustrating an example operating environment 200 in which techniques for crowdsourced radar map generation may be implemented according to aspects of the disclosure. In operating environment 200, a map generation system 202 can communicate with a plurality of vehicles 245 via a network 270. In various examples, any particular vehicle 245 can be a vehicle that comprises a UE, such as UE 105 of FIG. 1. In some examples, the network 270 can correspond to network 170 of FIG. 1.

As shown in FIG. 2, the map generation system 202 can provide the vehicles 245 with a radar reference map 240. Radar reference map 240 can be a reference map for use by vehicles 245 to conduct localization or simultaneous localization and mapping (SLAM) using radar in conjunction with autonomous or semi-autonomous operation on the part of vehicles 245. According to aspects of the disclosure, the map generation system 202 can construct the radar reference map 240 based on radar sensor data crowdsourced from vehicles 245. The vehicles 245 can generate the radar sensor data as they travel along highways, roads, and other paths of vehicular travel within a geographic domain of the radar reference map 240. The radar sensor data can comprise, indicate, or describe radar points (for instance, points of radar point clouds) that the vehicles 245 use radar sensors to capture during such travel. According to aspects of the disclosure, the map generation system 202 can logically subdivide the geographic domain of the radar reference map 240 into a plurality of map regions (such as map tiles), and can construct each map region based on radar points captured within that map region.

It is worthy of note that according to aspects of the disclosure, the any particular vehicle 245 may generate such sensor data while operating in an autonomous mode or semi-autonomous mode, but may also (or alternatively) generate such sensor data while operating in a non-autonomous (manual operation) mode. Further, in various examples, in constructing radar reference map 240, the map generation system 202 can use data crowdsourced from other vehicles, to which it does not provide radar reference map 240 (because, for instance, they are not capable of autonomous or semi-autonomous operation), in addition to (or in lieu of) data crowdsourced from vehicles 245 to which it does provide radar reference map 240.

According to aspects of the disclosure, the map generation system 202 can generate the radar reference map 240 according to a static occupancy grid (SOG) mapping algorithm. In some examples, according to the SOG mapping algorithm, each map region can be logically discretized into a grid of like-sized cells, and a respective occupancy probability can be estimated for each such cell. In some examples, the SOG mapping algorithm can be implemented using a two-dimensional (2D) grid, and the below discussion focuses, for exemplary purposes, on implementations involving the use of a 2D grid. However, in some other examples, the SOG mapping algorithm can be implemented using a three-dimensional (3D) grid.

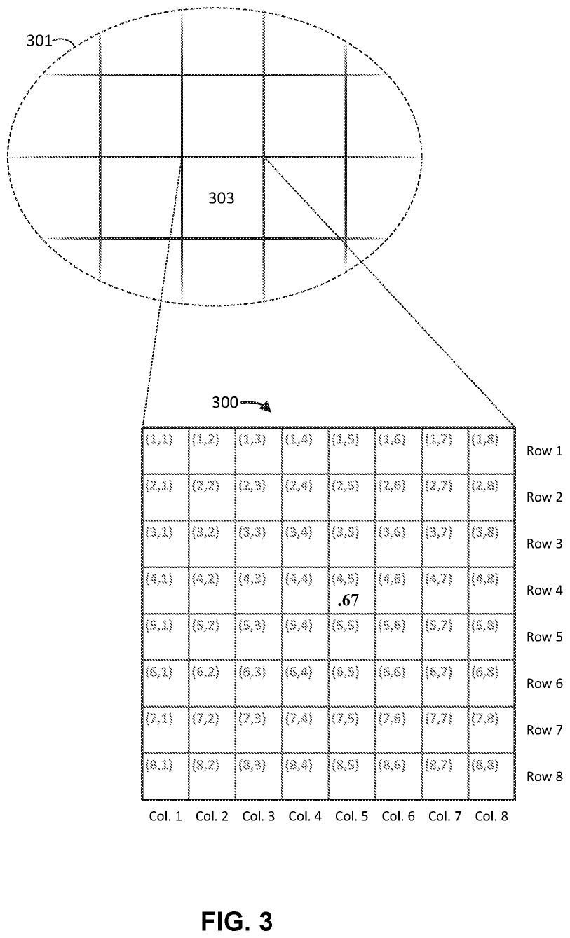

FIG. 3 illustrates an example of a mapping grid 300. Mapping grid 300 may be representative of a 2D SOG mapping grid for a map region of radar reference map 240 of FIG. 2, according to aspects of the disclosure. Mapping grid 300 subdivides a map region 303, which is one of a plurality of map regions within a geographical domain 301 of a radar reference map. According to aspects of the disclosure, map region 303 can correspond to a map region of the radar reference map 240 of FIG. 2.

As shown in FIG. 3, mapping grid 300 can comprise a plurality of cells arranged as a set of rows and columns. In the depicted example, mapping grid 300 includes eight rows and eight columns, and thus a total of sixty-four cells. Each cell can be uniquely identified by the combination of its row number i and column number j, as cell (i,j). Thus, for example, the cell in the first row and first column of mapping grid 400 can be referred to as cell (1,1), the cell in the second row and first column as cell (2,1), the cell in the first row and second column as cell (1,2), and so forth.

The probability that a given cell (i,j) of mapping grid 300 is occupied—the “occupancy probability” of the cell (i,j)—can be referred to using the notation p_{i,j}(O), where O is a binary value representing an occupied state. Thus, p_{1,1}(O) can represent the occupancy probability of cell (1,1), p_{2,1}(O) can represent the occupancy probability of cell (2,1), p_{1,2}(O) can represent the occupancy probability of cell (1,2), and so forth. In FIG. 3, an example value of 0.67 is shown for the occupancy probability p_{4,5}(O) of cell (4,5), indicating a 67% probability of cell (4,5) being occupied.

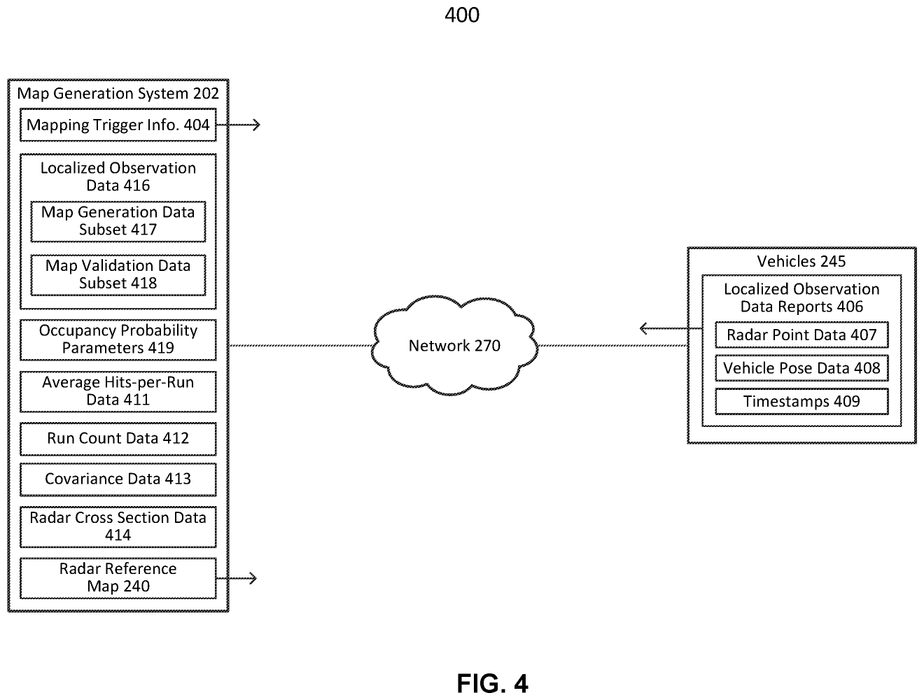

FIG. 4 is a block diagram illustrating an example operating environment 400 in which techniques for crowdsourced radar map generation may be implemented according to aspects of the disclosure. In operating environment 400, the map generation system 202 can control the reporting of localized observation data on the part of vehicles 245. In order to report localized observation data, vehicles 245 can send localized observation data reports 406 to map generation system 202. According to aspects of the disclosure, the map generation system 202 can control the submission of localized observation data reports 406 on a per-map region basis, in conjunction with implementing an SOG mapping algorithm.

In some examples, the map generation system 202 can send mapping trigger information 404 in order to instruct vehicles 245 to send localized observation data reports 406 for a given map region of the radar reference map 240. In some examples, the map generation system 202 can send mapping trigger information 404 to instruct vehicles 245 to send localized observation data reports 406 for a given map region responsive to a determination that radar reference map 240 lacks coverage of that map region, or a determination to improve a quality of radar reference map 240 for that map region. In various examples, the map generation system 202 can determine or detect that the quality of radar reference map 240 for the map region merits improvement based on failed radar localization reports associated with the map region (for instance, based on a number of failed radar localization reports received during a specified amount of time). In some examples, the map generation system 202 can send mapping trigger information 404 to provide vehicles 245 with a schedule (which may be periodic, aperiodic, or a combination of both) according to which vehicles 245 are to generate and provide localized observation data reports 406 for a given map region. For example, mapping trigger information 404 could indicate that vehicles 245 are to generate and provide localized observation data reports 406 the given map region if the travel within that map region during particular hours.

In various examples, the vehicles 245 can send the localized observation data reports 406 to the map generation system 202 via network 270. In some examples, the vehicles 245 can wirelessly transmit the localized observation data reports 406 to radio access network (RAN) base stations (such as base stations 120), from which the localized observation data reports 406 can pass to the map generation system 202 via the network 270. In some examples, the vehicles 245 can wirelessly transmit the localized observation data reports 406 over V2X links.

According to aspects of the disclosure, the map generation system 202 can obtain a set of localized observation data 416 associated with a map region by accumulating localized observation data from a plurality of localized observation data reports 406, and can determine occupancy probability parameters 419 for the map region based on the set of localized observation data 416. According to aspects of the disclosure, the map generation system 202 can divide the set of localized observation data 416 for the map region into a map generation data subset 417 and a map validation data subset 418. According to aspects of the disclosure, the map generation system 202 can determine the occupancy probability parameters 419 for the map region based on the map generation data subset 417, and can validate the occupancy probability parameters 419 for the map region based on the map validation data subset 418. Following determination and validation of the occupancy probability parameters 419 for the map region, the map generation system 202 can update the radar reference map 240 according to those occupancy probability parameters 419.

As shown in FIG. 4, the localized observation data reports 406 can include radar point data 407, vehicle pose data 408, and timestamps 409. The radar point data 407 in any given localized observation data report 406 for the map region can describe radar points (for instance, points of radar point clouds) that a vehicle 245 has captured while traveling in the map region. According to aspects of the disclosure, the radar point data 407 can indicate positions of the radar points according to a reference frame Fᵥ of the vehicle 245, which can be defined relative to the vehicle body. In some examples, for instance, the radar point data 407 can indicate coordinates of radar points relative to a point on a rear axle of the vehicle 245 that is designated as an origin v of the vehicle reference frame Fᵥ. In some examples, the radar point data 407 can indicate the coordinates of any given radar point p as a translation Tᵥₚ that represents a shift from the origin v to the point p, or as polar or spherical coordinates.

The vehicle pose data 408 can generally comprise information usable to determine the positions of the radar points according to a global reference frame F_{g} based on the positions of the radar points according to the vehicle reference frame Fᵥ. For example, the vehicle pose data 408 can indicate an orientation of the vehicle reference frame Fᵥ according to the global reference frame F_{g} and a location of the origin v of the vehicle reference frame according to the global reference frame F_{g}. In some examples, for any given radar point p, the vehicle pose data 408 can indicate a translation T_{gv} that represents a position of the capturing vehicle 245 at the time of capture according to the global reference frame F_{g}, as a shift from an origin g of the global reference frame F_{g} to the origin v of the vehicle reference frame Fᵥ. The vehicle pose data 408 can also indicate a rotation R_{gv} that represents an orientation of the capturing vehicle 245 at the time of capture according to the global reference frame F_{g}, as a rotation relative to an arbitrary direction (for example, due north) in the global reference frame F_{g}.

In operating environment 400, the map generation system 202 can implement an SOG mapping algorithm to generate or update a map region of radar reference map 240. According to the SOG mapping algorithm, occupancy probabilities for map region cells can be determined using input measurements indicating positions of radar points according to global reference frame F_{g}. According to aspects of the disclosure, the map generation system 202 can generate input measurements for the SOG mapping algorithm based on data obtained from received localized observation data reports 406. In some examples, for instance, map generation system 202 can generate input measurements for the SOG mapping algorithm by using a translation T_{gv} and a rotation R_{gv} indicated by vehicle pose data 408 to convert the vehicle reference frame-based coordinates Tᵥₚ of radar points described by radar point data 407 to global reference frame-based coordinates T_{gp}.

According to the SOG mapping algorithm, for a cell (i,j) in the map region at a time k, a conditional probability p_{i,j} (O|z₁, . . . , zₖ) can be estimated that represents a probability of the cell (i,j) being occupied given a cumulative set of input measurements as of the time k, where zₖ represents input measurements at the time k. A log-odds ratio l_{i,j}^{k} can be defined as a function of the conditional probability p_{i,j} (O|z₁, . . . , zₖ) according to Equation (1) as follows:

$${l}_{i , j}^{k} = ln \frac{{p}_{i , j} ( O \vert {z}_{1} , … , {z}_{k} )}{1 - {p}_{i , j} ( O \vert {z}_{1} , … , {z}_{k} )} \qquad ( 1 )$$

The conditional probability p_{i,j} (O|z₁, . . . , zₖ) can be expressed in terms of the log-odds ratio l_{l,j}^{k} according to Equation (2) as follows:

$${p}_{i , j} ( O \vert {z}_{1} , … , {z}_{k} ) = \frac{1}{1 + exp ( - {l}_{i , j}^{k} )} \qquad ( 2 )$$

According to the SOG mapping algorithm, the log-odds ratio l_{i,j}^{k} at time k can be determined using an occupancy probability specified by an inverse sensor model (ISM). The ISM can be a model that specifies a probability of a cell being occupied at a given time given the input measurements at that time. According to aspects of the disclosure, the log-odds ratio l_{i,j}^{k}, at time k can be determined based on the log-odds ratio i_{i,j}^{k-1} at a preceding time k−1 and the ISM occupancy probability at the time k. According to aspects of the disclosure, the log-odds ratio l_{i,j}^{k} at time k can be determined using a Bayesian update equation shown below as Equation (3):

$${l}_{i , j}^{k} = log \frac{{p}_{i , j} ( O \vert {z}_{k} )}{1 - {p}_{i , j} ( O \vert {z}_{k} )} - {l}_{i , j}^{0} + {l}_{i , j}^{k - 1} \qquad ( 3 )$$

where l_{i,j}⁰ represents the log-odds ratio corresponding to a prior occupancy probability p_{i,j}(O), and p_{i,j}(O|zₖ) represents the ISM occupancy probability at time k. Details regarding various potential implementations of an ISM in operating environment 400 are discussed below.

According to aspects of the disclosure, in addition to information comprised in received localized observation data reports 406, the map generation system 202 can use various other types of information in conjunction with generating the radar reference map 240 according to the SOG mapping algorithm. In some examples, such other types of information can include one or more of average hits-per-run data 411, run count data 412, covariance data 413, and radar cross section data 414.

Average hits-per-run data 411 can indicate average numbers of times that grid cells have radar hits per vehicle run on routes in the vicinities of those cells. In some examples, the averaging can be based on multiple routes in the vicinity of any given cell. In some examples, the average hits-per-run data 411 can take the form of prestored values representing a priori knowledge of hit-per-run rates for various map regions. In some other examples, the average hits-per-run data 411 can comprise hit-per-run rates that the map generation system 202 determines dynamically based on the radar point data 407 and the vehicle pose data 408 received from the vehicles 245.

Run count data 412 can indicate counts of the numbers of observed runs in various regions of the radar reference map 240 on the part of various vehicles 245. In some examples, the map generation system 202 can generate run count data 412 based on vehicle pose data 408 and identifiers comprised in received localized observation data reports 406. According to aspects of the disclosure, run count data 412 can indicate run counts associated with map links of the radar reference map 240. In some examples, such map links can be high-definition (HD) map links. In other examples, such map links can be standard-definition (SD) map links. According to aspects of the disclosure, each map link can indicate a section of roadway, and the associated run count can represent a count of a number of vehicles that have traversed that section of roadway since an initial time (which may correspond to a time at which the run count was set or reset to zero, for example). In some examples, each map link can be tagged with an identifier. According to aspects of the disclosure, each map link can be associated with an HD or SD radar map sub-tile that is a subsection of an HD or SD radar map tile. In an example, such an HD or SD radar map tile may correspond to a region of approximately 10 km×10 km, and may be subdivided into sub-tiles of a few hundred meters in length and width. Covariance data 413 can include data indicating covariances of the positions (according to the reference frames of vehicles 245) of radar points described by radar point data 407. Covariance data 413 can additionally or alternatively include data indicating covariances of vehicle poses indicated by vehicle pose data 408. Radar cross section data 414 can indicate radar cross sections associated with radar points described by radar point data 407.

In some examples, the SOG mapping algorithm can consider multiple runs as a single time series, and can use a first example ISM according to which the ISM probability p_{i,j} (O|zₖ) given measurements zₖ at time k is defined by Equation (4) as follows:

$${p}_{i , j} ( O \vert {z}_{k} ) = \{ \begin{matrix}{P}_{1} , & if at least one radar point in cell ( i , j ) at time k \\ {P}_{0} , & if no radar point in cell ( i , j ) at time k\end{matrix} \qquad ( 4 )$$

where P₁ and P₀ are constants, and 1≥P₁>P₀≥0. In some examples, P₁ can be equal to 0.5, and P₀ can be equal to 0.1. In some examples, the prior occupancy probability p_{i,j}(O) can be set to be equal to P₀, such that in cases in which no radar points are captured, the ISM probability p_{i,j} (O|zₖ) is the same as the prior occupancy probability p_{i,j}(O). The same feature—the ISM probability being the same as the prior occupancy probability when no radar points are captured—can be implemented in conjunction with the additional example ISMs discussed below. According to aspects of the disclosure, this can ensure that the occupancy probability does not decrease.

The log-odds ratios Δl_{i,j}^{k}, and l_{i,j}⁰ associated with the ISM probability p_{i,j}(O|zₖ) and the prior occupancy probability p_{i,j} (O), respectively, can be expressed according to Equations (5) and (6) as follow:

$$Δ {l}_{i , j}^{k} = ln \frac{{p}_{i , j} ( O \vert {z}_{k} )}{1 - {p}_{i , j} ( O \vert {z}_{k} )} \qquad ( 5 )$$

$${l}_{i , j}^{0} = ln \frac{{p}_{i , j} ( O )}{1 - {p}_{i , j} ( O )} \qquad ( 6 )$$

and the log-odds ratio l_{i,j}^{k}, associated with the occupancy probability at time k can be sequentially calculated according to Equation (7) as follows:

$${i}_{i , j}^{k} = Δ {l}_{i , j}^{k} - {l}_{i , j}^{0} + {l}_{i , j}^{k - 1} \qquad ( 7 )$$

According to some examples, in conjunction with use of the above first example ISM, all measurements across all times can be considered as a single time series. In such examples, there can be exactly one detection for which Bayesian update recursion occurs at each time step, and thus accommodation can be made for the possibility of multiple measurements in a same grid cell at a same time.

According to a second example ISM, the ISM probability p_{i,j} (O|zₖ) can be defined as a function of the number of runs and average hits-per-run in the map region, according to Equation (8) as follows:

$${p}_{i , j} ( O \vert {z}_{k} ) = \{ \begin{matrix}f ( HPR , X ) , & if at least one radar point in cell ( i , j ) at time k \\ {P}_{0} , & if no radar point in cell ( i , j ) at time k\end{matrix} \qquad ( 8 )$$

where HPR represents the average hits-per-run (such as may be indicated by average hits-per-run data 411) and X represents the number of runs (such as may be indicated by run count data 412). An exemplary function ƒ(HPR,X) according to which a desired occupancy probability P₂ (such as 0.9) is indicated for all cells with associated hits-per-run larger than HPR after X runs is shown as Equation (9) as follows:

$$f ( HPR , X ) = \frac{1}{1 + exp ( - \frac{( HPR * X - 1 ) * {l}_{i , j}^{0} + ln ( {P}_{2} )}{HPR * X} )} \qquad ( 9 )$$

In some examples, according to the second example ISM, the HPR of Equation (9) can be specific to the particular map region in question. In some other examples, the HPR can apply to all of the radar reference map 240. In some examples, the HPR can be estimated using a reference a priori available map, which may or may not be a crowdsourced map.

According to a third example ISM, the covariance of global reference frame-based coordinates T_{gp} (such as may be indicated by covariance data 413) can be used in conjunction with determining ISM probabilities. According to the third example ISM, a 3×3 group of cells centered around a cell containing a radar point can be updated with weights based on the covariance of T_{gp}. For each cell, a bivariate Gaussian value N(μ, covar (T_{gp})) can be determined and stored in a matrix Q, where μ is the center of the cell containing the radar point. The ISM probability can then be evaluated by determining a single-run ISM probability dependent on HPR and then updating it based on the number of runs. The single-run ISM probability can be determined according to Equation (10) as follows:

$${s}_{k , l} ( O \vert {z}_{k} ) = {p}_{k , l} ( O ) + \frac{P ( k , l )}{P ( i , j )} * sf \qquad ( 10 )$$

where sƒ is a function of HPR (for instance, inversely proportional to HPR, such that sƒ is equal to 1/HPR). The number of runs X can then be taken into account according to Equations (11) and (12) as follows:

$${p}_{i , j} ( O \vert {z}_{k} ) = \frac{1}{1 + exp ( - \frac{Δ {s}_{k , l}}{X} + \frac{X - 1}{X} * {l}_{i , j}^{0} )} \qquad ( 11 )$$

$$Δ {s}_{k , l} = ln ( \frac{{s}_{k , l}}{1 - {s}_{k , l}} ) \qquad ( 12 )$$

In some examples, the third example ISM can be applied in scenarios in which the total number of runs X is unknown when implementation of the mapping algorithm commences. In some such examples, each time an additional run is incorporated and the number of runs is incremented, the occupancy probability can be scaled based on the additional run, and the single-run ISM probability can be updated accordingly.

According to a fourth example ISM, computational complexity may be reduced relative to the third example ISM by averaging the covariances covar(T_{gp}) associated with timestamps having multiple associated radar points to obtain average covariances c̅o̅v̅a̅r̅(̅T̅_̅{̅g̅p̅}̅)̅ and determining ISM probabilities using those average covariances c̅o̅v̅a̅r̅(̅T̅_̅{̅g̅p̅}̅)̅. According to aspects of the disclosure, the covariances covar(T_{gp}) can be positive semidefinite matrices, and the average covariances c̅o̅v̅a̅r̅(̅T̅_̅{̅g̅p̅}̅)̅ can be convex combinations of covariances covar(T_{gp}), and therefore also can be positive semidefinite matrices.

In some examples, vehicles 245 can provide covariances covar(T_{gp}), average covariances c̅o̅v̅a̅r̅(̅T̅_̅{̅g̅p̅}̅)̅, or both to the map generation system 202 by including them in transmitted V2X messages. In some other examples, the map generation system 202 can determine covariances covar(T_{gp}), average covariances c̅o̅v̅a̅r̅(̅T̅_̅{̅g̅p̅}̅)̅, or both based on inputs that vehicles 245 provide by including them in transmitted V2X messages. In some examples, such inputs can include radar point range, azimuth, and elevation values and associated variances, calibration transforms (which can include rotations and translations, and can involve 6 degrees of freedom), and vehicle pose-related covariances, such as covar(T_{gv}) and covar(R_{gv}).

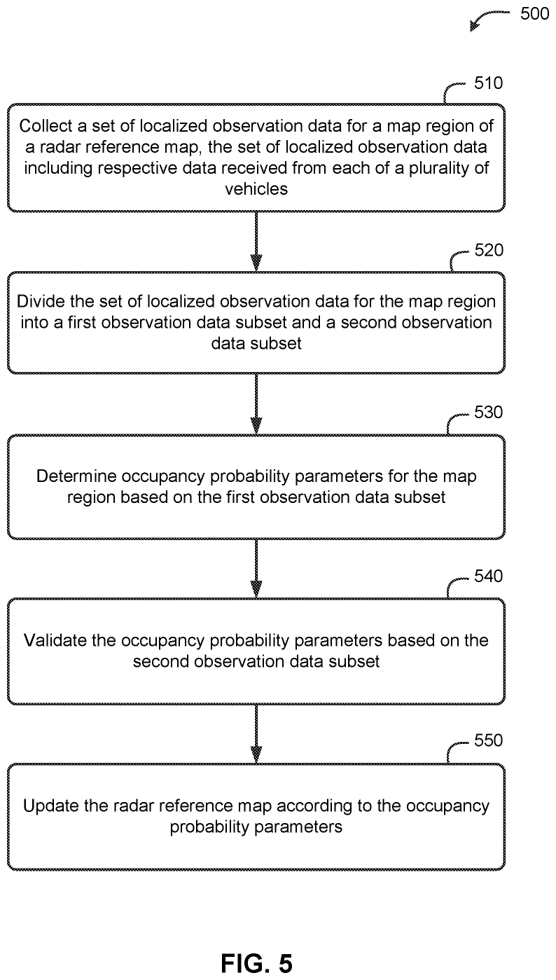

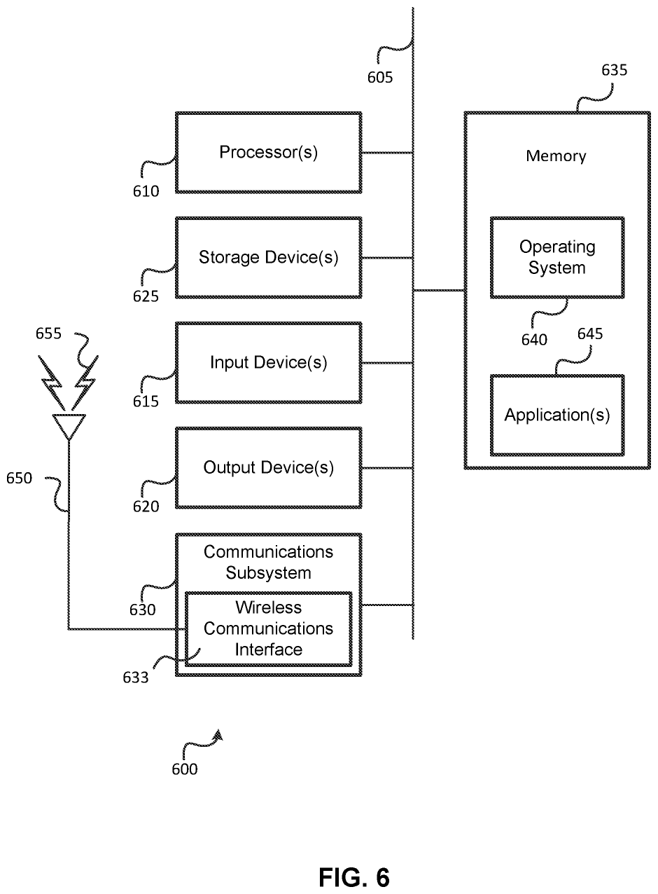

FIG. 5 is a block diagram illustrating an example map generation method 500, according to aspects of the disclosure. According to aspects of the disclosure, means for performing the functionality illustrated in one or more of the blocks shown in FIG. 5 may be performed by hardware and/or software components of a computer system. Example components of a computer system are illustrated in FIG. 6, which is described in more detail below. In some examples, map generation system 202 may perform the functionality illustrated in one or more of the blocks shown in FIG. 5 in operating environment 400 of FIG. 4.

At block 510, the functionality comprises collecting a set of localized observation data for a map region of a radar reference map, the set of localized observation data including respective data received from each of a plurality of vehicles. For example, in operating environment 400 of FIG. 4, map generation system 202 may collect a set of localized observation data 416 for a map region of radar reference map 240, and the set of localized observation data 416 may include respective data received from each of a plurality of vehicles 245. Means for performing functionality at block 510 may comprise a bus 605, processor(s) 610, storage device(s) 625, communications subsystem 630, memory 635, and/or other components of a computer system, as illustrated in FIG. 6.

According to aspects of the disclosure, the set of localized observation data can be obtained from a plurality of localized observation data reports received from the plurality of vehicles. In some examples, each of the plurality of localized observation data reports can include radar point data generated by a respective vehicle among the plurality of vehicles, and the radar point data can indicate positions of radar points captured by the respective vehicle according to a reference frame of the respective vehicle. In some examples, each of the plurality of localized observation data reports can include a covariance associated with the radar point data generated by the respective vehicle. In some examples, each of the plurality of localized observation data reports can include vehicle pose data generated by the respective vehicle, and the vehicle pose data can indicate an orientation of the reference frame of the respective vehicle according to a global reference frame at a time of capture of the radar points by the respective vehicle. In some examples, each of the plurality of localized observation data reports can include a covariance associated with the vehicle pose data generated by the respective vehicle. In some examples, each of the plurality of localized observation data reports can include a timestamp indicating a time of capture of the radar points by the respective vehicle.

According to aspects of the disclosure, mapping trigger information can be sent to instruct the plurality of vehicles to report localized observation data for the map region. In some examples, the mapping trigger information can be sent responsive to a determination that the radar reference map lacks coverage of the map region. In some other examples, the mapping trigger information can be sent responsive to a determination to improve a quality of the radar reference map for the map region.

At block 520, the functionality comprises dividing the set of localized observation data for the map region into a first observation data subset and a second observation data subset. For example, in operating environment 400 of FIG. 4, map generation system 202 may divide the set of localized observation data 416 for the map region into map generation data subset 417 and map validation data subset 418. Means for performing functionality at block 520 may comprise a bus 605, processor(s) 610, storage device(s) 625, communications subsystem 630, memory 635, and/or other components of a computer system, as illustrated in FIG. 6.

At block 530, the functionality comprises determining occupancy probability parameters for the map region based on the first observation data subset. For example, in operating environment 400 of FIG. 4, map generation system 202 may determine occupancy probability parameters 419 for the map region based on the map generation data subset 417. Means for performing functionality at block 530 may comprise a bus 605, processor(s) 610, storage device(s) 625, communications subsystem 630, memory 635, and/or other components of a computer system, as illustrated in FIG. 6.

At block 540, the functionality comprises validating the occupancy probability parameters based on the second observation data subset. For example, in operating environment 400 of FIG. 4, map generation system 202 may validate the occupancy probability parameters 419 based on the map validation data subset 418. Means for performing functionality at block 540 may comprise a bus 605, processor(s) 610, storage device(s) 625, communications subsystem 630, memory 635, and/or other components of a computer system, as illustrated in FIG. 6.

At block 550, the functionality comprises updating the radar reference map according to the occupancy probability parameters. For example, in operating environment 400 of FIG. 4, map generation system 202 may update the radar reference map 240 according to the occupancy probability parameters 419. Means for performing functionality at block 550 may comprise a bus 605, processor(s) 610, storage device(s) 625, communications subsystem 630, memory 635, and/or other components of a computer system, as illustrated in FIG. 6.

According to aspects of the disclosure, the radar reference map can be updated according to a static occupancy grid algorithm. In some examples, updating the radar reference map according to the static occupancy grid algorithm can include updating a run count associated with a map link of the radar reference map based on vehicle pose data included in a received localized observation data report, resulting in an updated run count, and determining an average hits-per-run parameter for a static occupancy grid cell based on the updated run count. In some examples, updating the radar reference map according to the static occupancy grid algorithm can include determining an occupancy probability for the static occupancy grid cell according to an inverse sensor model, based on the average hits-per-run parameter and the updated run count, and validating the static occupancy grid cell as an occupied cell based on a comparison of the occupancy probability for the static occupancy grid cell with a threshold.

FIG. 6 is a block diagram of an embodiment of a computer system 600, which may be used, in whole or in part, to provide the functions of one or more components as described in the embodiments herein. According to aspects of the disclosure, computer system 600 can be used in some examples to implement map generation system 202 of FIGS. 2 and 4, map generation method 500 of FIG. 5, or both. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. In addition, it can be noted that components illustrated by FIG. 6 can be localized to a single device and/or distributed among various networked devices, which may be disposed at different geographical locations.

The computer system 600 is shown comprising hardware elements that can be electrically coupled via a bus 605 (or may otherwise be in communication, as appropriate). The hardware elements may include processor(s) 610, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 600 also may comprise one or more input devices 615, which may comprise without limitation a mouse, a keyboard, a camera, a microphone, and/or the like; and one or more output devices 620, which may comprise without limitation a display device, a printer, and/or the like.

The computer system 600 may further include (and/or be in communication with) one or more non-transitory storage devices 625, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 600 may also include a communications subsystem 630, which may comprise wireless communication technologies managed and controlled by a wireless communication interface 633, as well as wired communication technologies (such as Ethernet, coaxial communications, universal serial bus (USB), and the like). The wired communication technologies can be managed and controlled by a wired communication interface (not shown in FIG. 6). The wireless communication interface 633 may comprise one or more wireless transceivers that may send and receive wireless signals 655 (e.g., signals according to 5G NR or LTE) via wireless antenna(s) 650. Thus the communications subsystem 630 may comprise a modem, a network card (wireless or wired), an infrared communication device, a wireless communication device, and/or a chipset, and/or the like, which may enable the computer system 600 to communicate on any or all of the communication networks described herein to any device on the respective network, including a User Equipment (UE), base stations and/or other TRPs, and/or any other electronic devices described herein. Hence, the communications subsystem 630 may be used to receive and send data as described in the embodiments herein.

In many embodiments, the computer system 600 will further comprise a working memory 635, which may comprise a RAM or ROM device, as described above. Software elements, shown as being located within the working memory 635, may comprise an operating system 640, device drivers, executable libraries, and/or other code, such as one or more applications 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as computer system 600. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

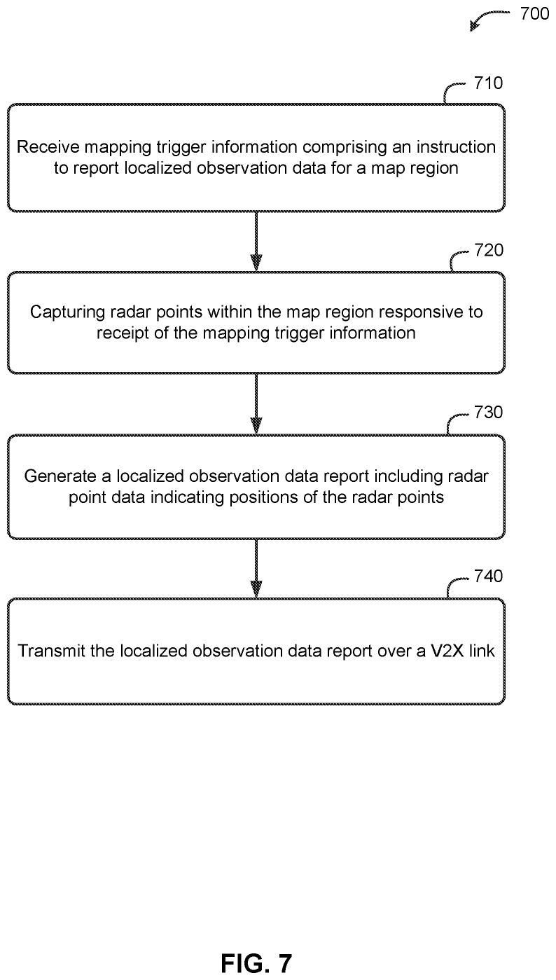

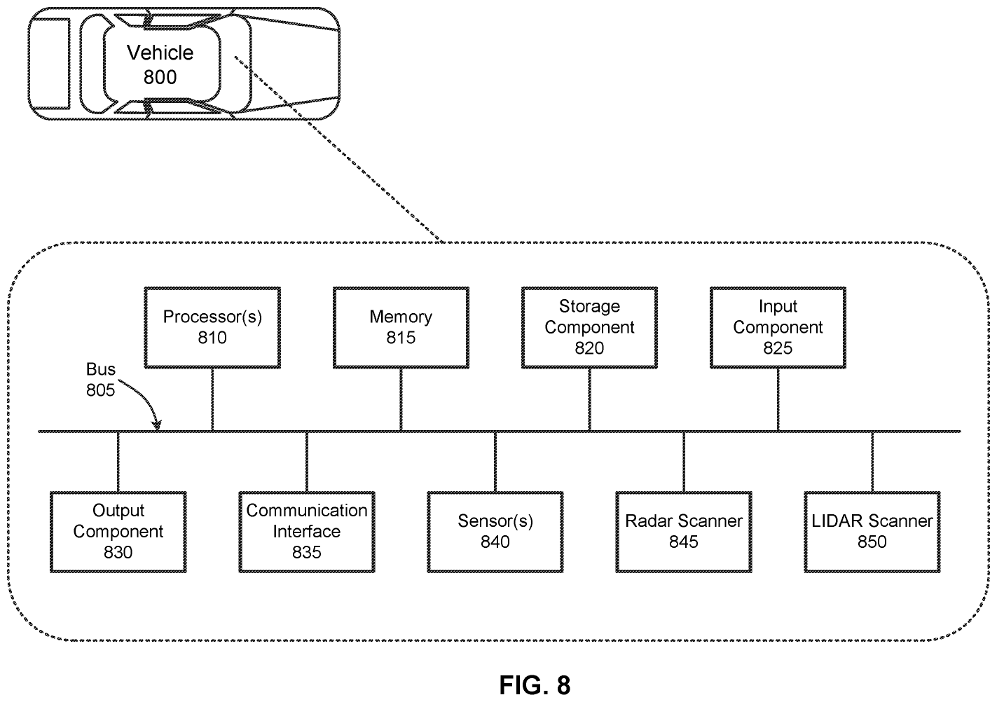

FIG. 7 is a block diagram illustrating an example map generation method 700, according to aspects of the disclosure. According to aspects of the disclosure, means for performing the functionality illustrated in one or more of the blocks shown in FIG. 7 may be performed by hardware and/or software components of a vehicle. Example components of a vehicle are illustrated in FIG. 8, which is described in more detail below. In some examples, a vehicle 245 may perform the functionality illustrated in one or more of the blocks shown in FIG. 7 in operating environment 400 of FIG. 4.

At block 710, the functionality comprises receiving mapping trigger information comprising an instruction to report localized observation data for a map region. For example, in operating environment 400 of FIG. 4, a vehicle 245 may receive mapping trigger information 404 comprising an instruction to report localized observation data for a map region of radar reference map 240. Means for performing functionality at block 710 may comprise a bus 805, processor(s) 810, memory 815, storage component 820, input component 825, output component 830, communication interface 835, radar scanner 845, and/or other components of a vehicle as illustrated in FIG. 8.

At block 720, the functionality comprises capturing radar points within the map region responsive to receipt of the mapping trigger information. For example, in operating environment 400 of FIG. 4, the vehicle 245 may capture radar points within the map region of radar reference map 240 responsive to receipt of the mapping trigger information 404. Means for performing functionality at block 720 may comprise a bus 805, processor(s) 810, memory 815, storage component 820, input component 825, output component 830, communication interface 835, radar scanner 845, and/or other components of a vehicle as illustrated in FIG. 8.

At block 730, the functionality comprises generating a localized observation data report including radar point data indicating positions of the radar points. For example, in operating environment 400 of FIG. 4, the vehicle 245 may generate a localized observation data report 406 that includes radar point data 407 indicating positions (according to the vehicle reference frame) of the radar points captured within the map region of radar reference map 240. Means for performing functionality at block 730 may comprise a bus 805, processor(s) 810, memory 815, storage component 820, input component 825, output component 830, communication interface 835, radar scanner 845, and/or other components of a vehicle as illustrated in FIG. 8.

At block 740, the functionality comprises transmitting the localized observation data report over a V2X link. For example, in operating environment 400 of FIG. 4, the vehicle 245 may transmit the localized observation data report 406 to network 270 over a V2X link, and the map generation system 202 may receive the localized observation data report 406 via the network 270. Means for performing functionality at block 740 may comprise a bus 805, processor(s) 810, memory 815, storage component 820, input component 825, output component 830, communication interface 835, radar scanner 845, and/or other components of a vehicle as illustrated in FIG. 8.

FIG. 8 is a diagram illustrating example components of a vehicle 800, in accordance with the present disclosure. According to aspects of the disclosure, vehicle 800 can correspond to any particular one of vehicles 245 in FIGS. 2 and 4, can be used to implement map generation method 700 of FIG. 7, or both. As shown in FIG. 8, vehicle 800 may include a bus 805, processor(s) 810, a memory 815, a storage component 820, an input component 825, an output component 830, a communication interface 835, sensor(s) 840, a radar scanner 845, a LIDAR scanner 850, and/or the like. The number and arrangement of components shown in FIG. 8 are provided as an example. In practice, the vehicle 800 may include additional components, fewer components, different components, or differently arranged components than those shown in FIG. 8.

The bus 805 includes a component that permits communication among the components of vehicle 800. Processor(s) 810 can be implemented in hardware, firmware, software, or a combination of hardware, firmware, and software. The processor(s) 810 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, the processor(s) 810 include one or more processors capable of being programmed to perform a function. The memory 815 includes a random access memory (RAM), a read only memory (ROM), and/or another type of dynamic or static storage device (such as a flash memory, a magnetic memory, and/or an optical memory) that stores information and/or instructions for use by the processor(s) 810.

The storage component 820 stores information and/or software related to the operation and use of vehicle 800. For example, the storage component 820 may include a hard disk (such as a magnetic disk, an optical disk, a magneto-optic disk, and/or a solid state disk), a compact disc (CD), a digital versatile disc (DVD), a floppy disk, a cartridge, a magnetic tape, and/or another type of non transitory computer-readable medium, along with a corresponding drive.

The input component 825 includes a component that permits vehicle 800 to receive information, such as via user input (such as a touch screen display, a keyboard, a keypad, a mouse, a button, a switch, and/or a microphone). Additionally, or alternatively, the input component 825 may include a component for determining a position or a location of the vehicle 800 (such as a global positioning system (GPS) component, a global navigation satellite system (GNSS) component, and/or the like) a sensor for sensing information (such as an accelerometer, a gyroscope, an actuator, another type of position or environment sensor, and/or the like). The output component 830 includes a component that provides output information from the vehicle 800 (such as a display, a speaker, a haptic feedback component, an audio or visual indicator, and/or the like).

The communication interface 835 includes a transceiver-like component (such as a transceiver and/or a separate receiver and transmitter) that enables the vehicle 800 to communicate with other devices, such as via a wired connection, a wireless connection, or a combination of wired and wireless connections. The communication interface 835 may permit the vehicle 800 to receive information from another device and/or provide information to another device. For example, the communication interface 835 may include an Ethernet interface, an optical interface, a coaxial interface, an infrared interface, a radio frequency interface, a universal serial bus (USB) interface, a wireless local area interface (such as a Wi-Fi interface), a cellular network interface, and/or the like.

The sensor(s) 840 include one or more devices capable of sensing characteristics associated with the vehicle 800. The sensor(s) 840 may include one or more integrated circuits (such as on a packaged silicon die) and/or one or more passive components of one or more flex circuits to enable communication with one or more components of the vehicle 800.

The sensor(s) 840 may include an optical sensor that has a field of view in which it may determine one or more characteristics of an environment of the vehicle 800. In some aspects, the sensor(s) 840 may include a camera. For example, the sensor(s) 840 may include a low-resolution camera (such as a video graphics array (VGA)) that is capable of capturing images that are less than one megapixel, images that are less than 1216×912 pixels, and/or the like. The sensor(s) 840 may be a low-power device (such as a device that consumes less than ten milliwatts (mW) of power) that has always-on capability while the vehicle 800 is powered on.

Additionally, or alternatively, the sensor(s) 840 may include magnetometer (such as a Hall effect sensor, an anisotropic magneto-resistive (AMR) sensor, a giant magneto-resistive sensor (GMR), and/or the like), a location sensor (such as a global positioning system (GPS) receiver, a local positioning system (LPS) device (such as that uses triangulation, multi-lateration, and/or the like), and/or the like), a gyroscope (such as a micro-electro-mechanical systems (MEMS) gyroscope or a similar type of device), an accelerometer, a speed sensor, a motion sensor, an infrared sensor, a temperature sensor, a pressure sensor, and/or the like.

The radar scanner 845 may include one or more devices that use radio waves to determine the range, angle, and/or velocity of objects, surfaces, structures, and/or the like based on radar data obtained by the radar scanner 845. According to aspects of the disclosure, the radar scanner 845 may generate radar point data that the vehicle 800 provides to a map generation system (such as map generation system 202 of FIGS. 2 and 4) to enable the map generation system to perform crowdsourced radar map generation as described herein. In various examples, the radar scanner 845 can be a millimeter wave (mmWave) radar sensor. The LIDAR scanner 850 may include one or more devices that use light in the form of a pulsed laser to measure distances of objects from the LIDAR scanner based on LIDAR data obtained by the LIDAR scanner 850.

The vehicle 800 may perform one or more processes described herein. The vehicle 800 may perform these processes based on the processor(s) 810 executing software instructions stored by a non transitory computer-readable medium, such as the memory 815 and/or the storage component 820. A computer-readable medium is defined herein as a non-transitory memory device. A memory device includes memory space within a single physical storage device or memory space spread across multiple physical storage devices.

Software instructions may be read into the memory 815 and/or the storage component 820 from another computer-readable medium or from another device via the communication interface 835. When executed, software instructions stored in the memory 815 and/or the storage component 820 may cause the processor(s) 810 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, the vehicle 800 includes means for performing one or more processes described herein and/or means for performing one or more operations of the processes described herein. For example, vehicle 800 may include means for receiving mapping trigger information comprising an instruction to report localized observation data for a map region; means for capturing radar points within the map region responsive to receipt of the mapping trigger information; means for generating a localized observation data report including radar point data indicating positions of the radar points; and means for transmitting the localized observation data report over a V2X link; or the like. In some aspects, such means may include one or more components of the vehicle 800 described in connection with FIG. 8, such as the bus 805, the processor(s) 810, the memory 815, the storage component 820, the input component 825, the output component 830, the communication interface 835, the sensor(s) 840, the radar scanner 845, and/or the LIDAR scanner 850.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A radar map generation method, including collecting a set of localized observation data for a map region of a radar reference map, the set of localized observation data including respective data received from each of a plurality of vehicles, dividing the set of localized observation data for the map region into a first observation data subset and a second observation data subset, determining occupancy probability parameters for the map region based on the first observation data subset, validating the occupancy probability parameters based on the second observation data subset, and updating the radar reference map according to the occupancy probability parameters.

Clause 2. The radar map generation method of clause 1, further including collecting the set of localized observation data from a plurality of localized observation data reports received from the plurality of vehicles.

Clause 3. The radar map generation method of clause 2, where each of the plurality of localized observation data reports includes radar point data generated by a respective vehicle among the plurality of vehicles, the radar point data indicating positions of radar points captured by the respective vehicle according to a reference frame of the respective vehicle.

Clause 4. The radar map generation method of clause 3, where each of the plurality of localized observation data reports includes a covariance associated with the radar point data generated by the respective vehicle.

Clause 5. The radar map generation method of any of clauses 3 to 4, where each of the plurality of localized observation data reports includes vehicle pose data generated by the respective vehicle, the vehicle pose data indicating an orientation of the reference frame of the respective vehicle according to a global reference frame at a time of capture of the radar points by the respective vehicle.

Clause 6. The radar map generation method of clause 5, where each of the plurality of localized observation data reports includes a covariance associated with the vehicle pose data generated by the respective vehicle.

Clause 7. The radar map generation method of any of clauses 3 to 6, where each of the plurality of localized observation data reports includes a timestamp indicating a time of capture of the radar points by the respective vehicle.

Clause 8. The radar map generation method of any of clauses 1 to 7, further including sending mapping trigger information to instruct the plurality of vehicles to report localized observation data for the map region.

Clause 9. The radar map generation method of clause 8, further including sending the mapping trigger information responsive to a determination that the radar reference map lacks coverage of the map region.

Clause 10. The radar map generation method of clause 8, further including sending the mapping trigger information responsive to a determination to improve a quality of the radar reference map for the map region.

Clause 11. The radar map generation method of any of clauses 1 to 10, further including updating the radar reference map according to a static occupancy grid algorithm.

Clause 12. The radar map generation method of clause 11, where updating the radar reference map according to the static occupancy grid algorithm includes updating a run count associated with a map link of the radar reference map based on vehicle pose data included in a received localized observation data report, resulting in an updated run count, and determining an average hits-per-run parameter for a static occupancy grid cell based on the updated run count.

Clause 13. The radar map generation method of clause 12, where updating the radar reference map according to the static occupancy grid algorithm includes determining an occupancy probability for the static occupancy grid cell according to an inverse sensor model, based on the average hits-per-run parameter and the updated run count, and validating the static occupancy grid cell as an occupied cell based on a comparison of the occupancy probability for the static occupancy grid cell with a threshold.

Clause 14. An apparatus for radar map generation, the apparatus including a communication interface, a memory, and one or more processors communicatively coupled with the communication interface and the memory, where the one or more processors are configured to collect, via the communication interface, a set of localized observation data for a map region of a radar reference map, the set of localized observation data including respective data received from each of a plurality of vehicles, divide the set of localized observation data for the map region into a first observation data subset and a second observation data subset, determine occupancy probability parameters for the map region based on the first observation data subset, validate the occupancy probability parameters based on the second observation data subset, and update the radar reference map according to the occupancy probability parameters.

Clause 15. The apparatus of clause 14, where the one or more processors are configured to collect the set of localized observation data from a plurality of localized observation data reports received from the plurality of vehicles.

Clause 16. The apparatus of clause 15, where, to obtain the set of localized observation data from each of the plurality of localized observation data reports, the one or more processors are configured to obtain, from each of the plurality of localized observation data reports, radar point data generated by a respective vehicle among the plurality of vehicles, the radar point data indicating positions of radar points captured by the respective vehicle according to a reference frame of the respective vehicle.

Clause 17. The apparatus of clause 16, where, to obtain the set of localized observation data from each of the plurality of localized observation data reports, the one or more processors are configured to obtain, from each of the plurality of localized observation data reports, a covariance associated with the radar point data generated by the respective vehicle.

Clause 18. The apparatus of any of clauses 16 to 17, where, to obtain the set of localized observation data from each of the plurality of localized observation data reports, the one or more processors are configured to obtain, from each of the plurality of localized observation data reports, vehicle pose data generated by the respective vehicle, the vehicle pose data indicating an orientation of the reference frame of the respective vehicle according to a global reference frame at a time of capture of the radar points by the respective vehicle.

Clause 19. The apparatus of clause 18, where, to obtain the set of localized observation data from each of the plurality of localized observation data reports, the one or more processors are configured to obtain, from each of the plurality of localized observation data reports, a covariance associated with the vehicle pose data generated by the respective vehicle.

Clause 20. The apparatus of any of clauses 16 to 19, where, to obtain the set of localized observation data from each of the plurality of localized observation data reports, the one or more processors are configured to obtain, from each of the plurality of localized observation data reports, a timestamp indicating a time of capture of the radar points by the respective vehicle.

Clause 21. The apparatus of any of clauses 14 to 20, where the one or more processors are configured to send mapping trigger information to instruct the plurality of vehicles to report localized observation data for the map region.

Clause 22. The apparatus of clause 21, where the one or more processors are configured to send the mapping trigger information responsive to a determination that the radar reference map lacks coverage of the map region.

Clause 23. The apparatus of clause 21, where the one or more processors are configured to send the mapping trigger information responsive to a determination to improve a quality of the radar reference map for the map region.

Clause 24. The apparatus of any of clauses 14 to 23, where the one or more processors are configured to update the radar reference map according to a static occupancy grid algorithm.

Clause 25. The apparatus of clause 24, where, to update the radar reference map according to the static occupancy grid algorithm, the one or more processors are configured to update a run count associated with a map link of the radar reference map based on vehicle pose data included in a received localized observation data report, resulting in an updated run count, and determine an average hits-per-run parameter for a static occupancy grid cell based on the updated run count.

Clause 26. The apparatus of clause 25, where, to update the radar reference map according to the static occupancy grid algorithm, the one or more processors are configured to determine an occupancy probability for the static occupancy grid cell according to an inverse sensor model, based on the average hits-per-run parameter and the updated run count, and validate the static occupancy grid cell as an occupied cell based on a comparison of the occupancy probability for the static occupancy grid cell with a threshold.

Clause 27. An apparatus for radar map generation, the apparatus including means for collecting a set of localized observation data for a map region of a radar reference map, the set of localized observation data including respective data received from each of a plurality of vehicles, means for dividing the set of localized observation data for the map region into a first observation data subset and a second observation data subset, means for determining occupancy probability parameters for the map region based on the first observation data subset, means for validating the occupancy probability parameters based on the second observation data subset, and means for updating the radar reference map according to the occupancy probability parameters.

Clause 28. The apparatus of clause 27, further including means for collecting the set of localized observation data from a plurality of localized observation data reports received from the plurality of vehicles.

Clause 29. The apparatus of clause 28, where each of the plurality of localized observation data reports includes radar point data generated by a respective vehicle among the plurality of vehicles, the radar point data indicating positions of radar points captured by the respective vehicle according to a reference frame of the respective vehicle.

Clause 30. The apparatus of clause 29, where each of the plurality of localized observation data reports includes a covariance associated with the radar point data generated by the respective vehicle.

Clause 31. The apparatus of any of clauses 29 to 30, where each of the plurality of localized observation data reports includes vehicle pose data generated by the respective vehicle, the vehicle pose data indicating an orientation of the reference frame of the respective vehicle according to a global reference frame at a time of capture of the radar points by the respective vehicle.

Clause 32. The apparatus of clause 31, where each of the plurality of localized observation data reports includes a covariance associated with the vehicle pose data generated by the respective vehicle.

Clause 33. The apparatus of any of clauses 29 to 32, where each of the plurality of localized observation data reports includes a timestamp indicating a time of capture of the radar points by the respective vehicle.

Clause 34. The apparatus of any of clauses 27 to 33, further including means for sending mapping trigger information to instruct the plurality of vehicles to report localized observation data for the map region.

Clause 35. The apparatus of clause 34, further including means for sending the mapping trigger information responsive to a determination that the radar reference map lacks coverage of the map region.

Clause 36. The apparatus of clause 34, further including means for sending the mapping trigger information responsive to a determination to improve a quality of the radar reference map for the map region.

Clause 37. The apparatus of any of clauses 27 to 36, further including means for updating the radar reference map according to a static occupancy grid algorithm.

Clause 38. The apparatus of clause 37, where the means for updating the radar reference map according to the static occupancy grid algorithm includes means for updating a run count associated with a map link of the radar reference map based on vehicle pose data included in a received localized observation data report, resulting in an updated run count, and means for determining an average hits-per-run parameter for a static occupancy grid cell based on the updated run count.

Clause 39. The apparatus of clause 38, where the means for updating the radar reference map according to the static occupancy grid algorithm includes means for determining an occupancy probability for the static occupancy grid cell according to an inverse sensor model, based on the average hits-per-run parameter and the updated run count, and means for validating the static occupancy grid cell as an occupied cell based on a comparison of the occupancy probability for the static occupancy grid cell with a threshold.

Clause 40. A non-transitory computer-readable medium storing instructions for radar map generation, the instructions including code for collecting a set of localized observation data for a map region of a radar reference map, the set of localized observation data including respective data received from each of a plurality of vehicles, dividing the set of localized observation data for the map region into a first observation data subset and a second observation data subset, determining occupancy probability parameters for the map region based on the first observation data subset, validating the occupancy probability parameters based on the second observation data subset, and updating the radar reference map according to the occupancy probability parameters.

Clause 41. The non-transitory computer-readable medium of clause 40, the instructions further including code for collecting the set of localized observation data from a plurality of localized observation data reports received from the plurality of vehicles.

Clause 42. The non-transitory computer-readable medium of clause 41, where each of the plurality of localized observation data reports includes radar point data generated by a respective vehicle among the plurality of vehicles, the radar point data indicating positions of radar points captured by the respective vehicle according to a reference frame of the respective vehicle.

Clause 43. The non-transitory computer-readable medium of clause 42, where each of the plurality of localized observation data reports includes a covariance associated with the radar point data generated by the respective vehicle.

Clause 44. The non-transitory computer-readable medium of any of clauses 42 to 43, where each of the plurality of localized observation data reports includes vehicle pose data generated by the respective vehicle, the vehicle pose data indicating an orientation of the reference frame of the respective vehicle according to a global reference frame at a time of capture of the radar points by the respective vehicle.

Clause 45. The non-transitory computer-readable medium of clause 44, where each of the plurality of localized observation data reports includes a covariance associated with the vehicle pose data generated by the respective vehicle.

Clause 46. The non-transitory computer-readable medium of any of clauses 42 to 45, where each of the plurality of localized observation data reports includes a timestamp indicating a time of capture of the radar points by the respective vehicle.

Clause 47. The non-transitory computer-readable medium of any of clauses 40 to 46, the instructions further including code for sending mapping trigger information to instruct the plurality of vehicles to report localized observation data for the map region.

Clause 48. The non-transitory computer-readable medium of clause 47, the instructions further including code for sending the mapping trigger information responsive to a determination that the radar reference map lacks coverage of the map region.

Clause 49. The non-transitory computer-readable medium of clause 47, the instructions further including code for sending the mapping trigger information responsive to a determination to improve a quality of the radar reference map for the map region.

Clause 50. The non-transitory computer-readable medium of any of clauses 40 to 49, the instructions further including code for updating the radar reference map according to a static occupancy grid algorithm.

Clause 51. The non-transitory computer-readable medium of clause 50, where updating the radar reference map according to the static occupancy grid algorithm includes updating a run count associated with a map link of the radar reference map based on vehicle pose data included in a received localized observation data report, resulting in an updated run count, and determining an average hits-per-run parameter for a static occupancy grid cell based on the updated run count.

Clause 52. The non-transitory computer-readable medium of clause 51, where updating the radar reference map according to the static occupancy grid algorithm includes determining an occupancy probability for the static occupancy grid cell according to an inverse sensor model, based on the average hits-per-run parameter and the updated run count, and validating the static occupancy grid cell as an occupied cell based on a comparison of the occupancy probability for the static occupancy grid cell with a threshold.

What is claimed is:

1. A radar map generation method, comprising:
collecting a set of localized observation data for a map region of a radar reference map, the set of localized observation data including respective data received from each of a plurality of vehicles;
dividing the set of localized observation data for the map region into a first observation data subset and a second observation data subset;
determining occupancy probability parameters for the map region based on the first observation data subset;
validating the occupancy probability parameters based on the second observation data subset; and
updating the radar reference map according to the occupancy probability parameters.

2. The radar map generation method of claim 1, further comprising collecting the set of localized observation data from a plurality of localized observation data reports received from the plurality of vehicles.

3. The radar map generation method of claim 2, wherein each of the plurality of localized observation data reports includes radar point data generated by a respective vehicle among the plurality of vehicles, the radar point data indicating positions of radar points captured by the respective vehicle according to a reference frame of the respective vehicle.

4. The radar map generation method of claim 3, wherein each of the plurality of localized observation data reports includes a covariance associated with the radar point data generated by the respective vehicle.

5. The radar map generation method of claim 3, wherein each of the plurality of localized observation data reports includes vehicle pose data generated by the respective vehicle, the vehicle pose data indicating an orientation of the reference frame of the respective vehicle according to a global reference frame at a time of capture of the radar points by the respective vehicle.

6. The radar map generation method of claim 5, wherein each of the plurality of localized observation data reports includes a covariance associated with the vehicle pose data generated by the respective vehicle.

7. The radar map generation method of claim 3, wherein each of the plurality of localized observation data reports includes a timestamp indicating a time of capture of the radar points by the respective vehicle.

8. The radar map generation method of claim 1, further comprising sending mapping trigger information to instruct the plurality of vehicles to report localized observation data for the map region.

9. The radar map generation method of claim 8, further comprising sending the mapping trigger information responsive to a determination that the radar reference map lacks coverage of the map region.

10. The radar map generation method of claim 8, further comprising sending the mapping trigger information responsive to a determination to improve a quality of the radar reference map for the map region.

11. The radar map generation method of claim 1, further comprising updating the radar reference map according to a static occupancy grid algorithm.

12. The radar map generation method of claim 11, wherein updating the radar reference map according to the static occupancy grid algorithm comprises:
updating a run count associated with a map link of the radar reference map based on vehicle pose data included in a received localized observation data report, resulting in an updated run count; and
determining an average hits-per-run parameter for a static occupancy grid cell based on the updated run count.

13. The radar map generation method of claim 12, wherein updating the radar reference map according to the static occupancy grid algorithm comprises:
determining an occupancy probability for the static occupancy grid cell according to an inverse sensor model, based on the average hits-per-run parameter and the updated run count; and
validating the static occupancy grid cell as an occupied cell based on a comparison of the occupancy probability for the static occupancy grid cell with a threshold.

14. An apparatus for radar map generation, the apparatus comprising:
a communication interface;
a memory; and
one or more processors communicatively coupled with the communication interface and the memory, wherein the one or more processors are configured to:
collect, via the communication interface, a set of localized observation data for a map region of a radar reference map, the set of localized observation data including respective data received from each of a plurality of vehicles;
divide the set of localized observation data for the map region into a first observation data subset and a second observation data subset;
determine occupancy probability parameters for the map region based on the first observation data subset;
validate the occupancy probability parameters based on the second observation data subset; and
update the radar reference map according to the occupancy probability parameters.

15. The apparatus of claim 14, wherein the one or more processors are configured to collect the set of localized observation data from a plurality of localized observation data reports received from the plurality of vehicles.

16. The apparatus of claim 15, wherein, to obtain the set of localized observation data from each of the plurality of localized observation data reports, the one or more processors are configured to obtain, from each of the plurality of localized observation data reports, radar point data generated by a respective vehicle among the plurality of vehicles, the radar point data indicating positions of radar points captured by the respective vehicle according to a reference frame of the respective vehicle.

17. The apparatus of claim 16, wherein, to obtain the set of localized observation data from each of the plurality of localized observation data reports, the one or more processors are configured to obtain, from each of the plurality of localized observation data reports, a covariance associated with the radar point data generated by the respective vehicle.

18. The apparatus of claim 16, wherein, to obtain the set of localized observation data from each of the plurality of localized observation data reports, the one or more processors are configured to obtain, from each of the plurality of localized observation data reports, vehicle pose data generated by the respective vehicle, the vehicle pose data indicating an orientation of the reference frame of the respective vehicle according to a global reference frame at a time of capture of the radar points by the respective vehicle.

19. The apparatus of claim 18, wherein, to obtain the set of localized observation data from each of the plurality of localized observation data reports, the one or more processors are configured to obtain, from each of the plurality of localized observation data reports, a covariance associated with the vehicle pose data generated by the respective vehicle.

20. The apparatus of claim 16, wherein, to obtain the set of localized observation data from each of the plurality of localized observation data reports, the one or more processors are configured to obtain, from each of the plurality of localized observation data reports, a timestamp indicating a time of capture of the radar points by the respective vehicle.

21. The apparatus of claim 14, wherein the one or more processors are configured to send mapping trigger information to instruct the plurality of vehicles to report localized observation data for the map region.

22. The apparatus of claim 21, wherein the one or more processors are configured to send the mapping trigger information responsive to a determination that the radar reference map lacks coverage of the map region.

23. The apparatus of claim 21, wherein the one or more processors are configured to send the mapping trigger information responsive to a determination to improve a quality of the radar reference map for the map region.

24. The apparatus of claim 14, wherein the one or more processors are configured to update the radar reference map according to a static occupancy grid algorithm.

25. The apparatus of claim 24, wherein, to update the radar reference map according to the static occupancy grid algorithm, the one or more processors are configured to:
update a run count associated with a map link of the radar reference map based on vehicle pose data included in a received localized observation data report, resulting in an updated run count; and
determine an average hits-per-run parameter for a static occupancy grid cell based on the updated run count.

26. The apparatus of claim 25, wherein, to update the radar reference map according to the static occupancy grid algorithm, the one or more processors are configured to:
determine an occupancy probability for the static occupancy grid cell according to an inverse sensor model, based on the average hits-per-run parameter and the updated run count; and
validate the static occupancy grid cell as an occupied cell based on a comparison of the occupancy probability for the static occupancy grid cell with a threshold.

27. An apparatus for radar map generation, the apparatus comprising:
means for collecting a set of localized observation data for a map region of a radar reference map, the set of localized observation data including respective data received from each of a plurality of vehicles;
means for dividing the set of localized observation data for the map region into a first observation data subset and a second observation data subset;
means for determining occupancy probability parameters for the map region based on the first observation data subset;
means for validating the occupancy probability parameters based on the second observation data subset; and
means for updating the radar reference map according to the occupancy probability parameters.

28. The apparatus of claim 27, further comprising means for collecting the set of localized observation data from a plurality of localized observation data reports received from the plurality of vehicles.

29. The apparatus of claim 28, wherein each of the plurality of localized observation data reports includes radar point data generated by a respective vehicle among the plurality of vehicles, the radar point data indicating positions of radar points captured by the respective vehicle according to a reference frame of the respective vehicle.

30. A non-transitory computer-readable medium storing instructions for radar map generation, the instructions comprising code for:
collecting a set of localized observation data for a map region of a radar reference map, the set of localized observation data including respective data received from each of a plurality of vehicles;
dividing the set of localized observation data for the map region into a first observation data subset and a second observation data subset;
determining occupancy probability parameters for the map region based on the first observation data subset;
validating the occupancy probability parameters based on the second observation data subset; and
updating the radar reference map according to the occupancy probability parameters.
